(19) United States
(12) Patent Application Publication
(10) Pub. No.: US 2008/0236412 A1
(43) Pub. Date: Oct. 2, 2008

(54) Nano-imprinting method using material having surface energy

(75) Inventors: Chun-Hung Lin, Jhubel City (TW); Feng-Chih Chang, Hsinchu City (TW); Chih-Feng Wang, Tainan City (TW)

Correspondence Address: TROXELL LAW OFFICE PLLC, 5205 LEESBURG PIKE, SUITE 1404, FALLS CHURCH, VA, 22041, US

(73) Assignee: National Applied Research Laboratories, Taipei (TW)

(21) Appl. No.: 11/727,897

(22) Filed: Mar. 28, 2007

(51) Int. Cl. B41C 1/06

(52) U.S. Cl. 101/34

(57) ABSTRACT

A mold release agent of polybenzoxazine is used in an imprinting process. With the novel mold release agent used, a surface energy of a template is greatly reduced, so that an excel lent imprinted image is obtained. Besides, the mold release agent is totally resolved in a solution with no pollution produced. In short, the present invention has a high stability and a low cost with easy-obtained source materials.

### FIELD OF THE INVENTION

The present invention relates to a nano-imprinting method; more particularly, relates to utilizing a mold release agent of polybenzoxazine, obtained with benzoxazine monomer through a hot cross-linkage reaction, to reduce a surface energy of a template for obtaining a fine imprinted image on a polymer resist.

### DESCRIPTION OF THE RELATED ART

In a nano-imprinting, an adhering force between a template and a polymer resist may ruin an imprinted image. As shown in FIG. 13 to FIG. 15, the templates do not use any mold release agent. And, so, obvious defects are shown on surfaces of polymer resists after imprinting. To reduce the adhering force on departing the template from the polymer resist, a mold release agent is applied on a surface of the template. The molecules of the mold release agent reduce the surface energy of the template to conquer the adhering force on departing the template from the polymer resist.

A general mold release agent used is a fluorine-containing siloxane group compound. Although the mold release agent is used in imprinting, the silane-coupling agent of the fluorine-containing siloxane group compound forms particles through a synthesis reaction. Then, the particles are deposited on the surface of the template to form a non-uniformed surface and a bad imprinted image obtained afterwards.

Furthermore, forming a film of fluorine-containing siloxane group compound is affected by a few factors, such as temperature, water-containing rate, solution agent, coupling agent density, etc., whose effects are not totally known. Besides, the fluorine-containing siloxane monomer is expensive and hard to be stored. Hence, the prior art does not fulfill all users' requests on actual use.

### SUMMARY OF THE INVENTION

The main purpose of the present invention is to utilize a mold release agent of polybenzoxazine obtained with benzoxazine monomer through a hot cross-linkage reaction to reduce a surface energy of a template for obtaining a fine imprinted image on a polymer resist.

Another purpose of the present invention is to obtain a mold release agent having a high stability and a low cost with easy-obtained source materials while no pollution of particles is produced.

A third purpose of the present invention is to obtain the polybenzoxazine with more than two benzoxazine monomers through a hot cross-linkage reaction.

To achieve the above purposes, the present invention is a nano-imprinting method using a material having a surface energy, where a fine imprinted image is obtained with a template having a mold release agent of polybenzoxazine to reduce a surface energy of the template; and where the polybenzoxazine is obtained with benzoxazine monomer through a hot cross-linkage reaction on the surface of the template. Accordingly, a novel nano-imprinting method using a material having a surface energy is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the flow view showing the preferred embodiment according to the present invention;

FIG. 2 is the structural view showing the template;

FIG. 3 is the structural view showing the polymer resist added on the template;

FIG. 4 is the structural view showing the mold release agent added on the substrate;

FIG. 5 is the structural view showing the template being impressed on the substrate;

FIG. 6 is the view showing the imprinted substrate;

FIG. 7 is the view showing the chemical structure of the mono-functional group polybenzoxazine;

FIG. 8 is the view showing the chemical structure of the dual functional group polybenzoxazine;

FIG. 9 is the view showing the chemical structure of the benzoxazine monomer synthesized;

FIG. 10 is the view showing the imprinted image of 147 nanometers (nm);

FIG. 11 is the view showing the imprinted image of 648 nm;

FIG. 12 is the view showing the imprinted image of 140 nm;

FIG. 13 is the view of the 147 nm imprinted image of the prior art;

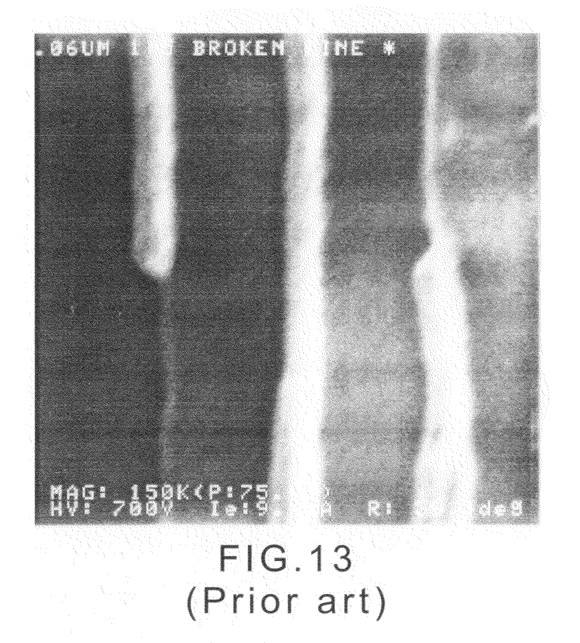

FIG. 14 is the view of the 648 nm imprinted image of the prior art; and

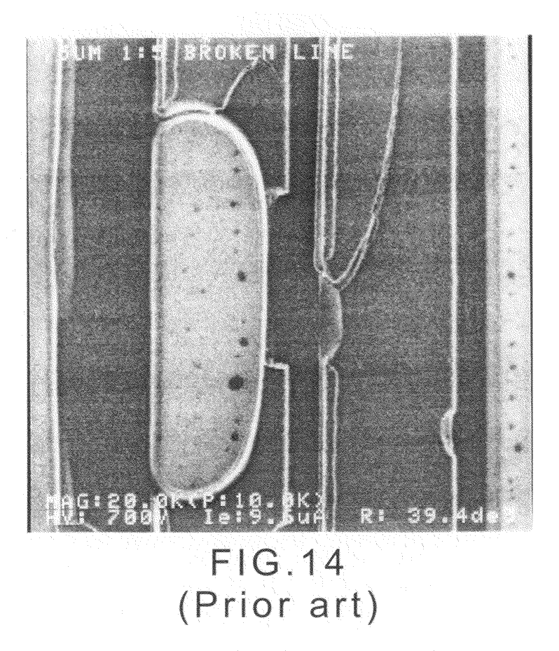

FIG. 15 is the view of the 140 nm imprinted image of the prior art.

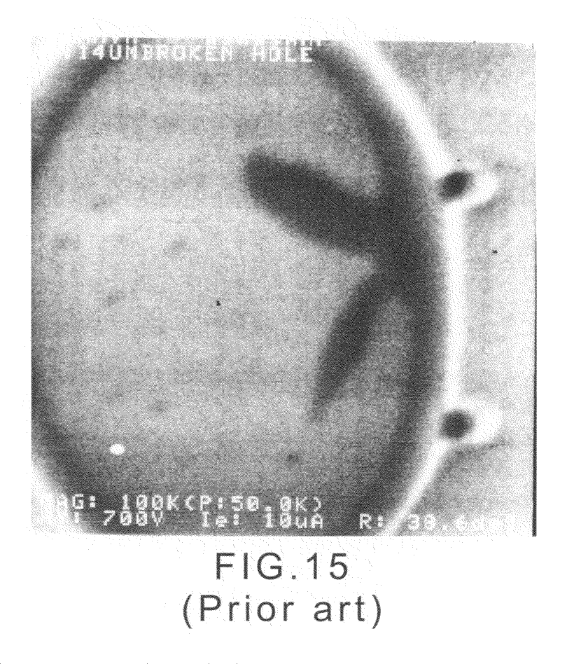

### DESCRIPTION OF THE PREFERRED EMBODIMENT

The following description of the preferred embodiment is provided to understand the features and the structures of the present invention.

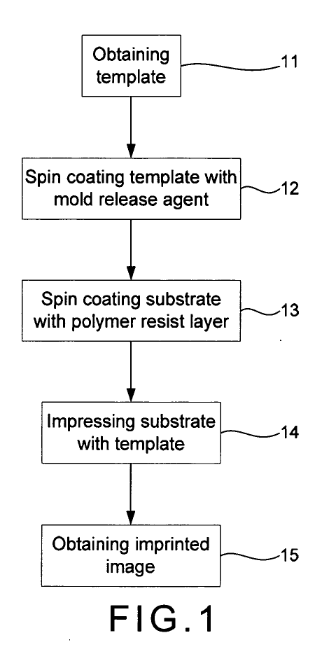

Please refer to FIG. 1 to FIG. 6, which are a flow view showing the preferred embodiment; and structural views showing a template, a polymer resist added on the template, a mold release agent added on a substrate, the template being impressed on the substrate and an imprinted substrate according to the present invention. As shown in the figures, the present invention is a nano-imprinting method using a material having a surface energy, comprising the following steps:

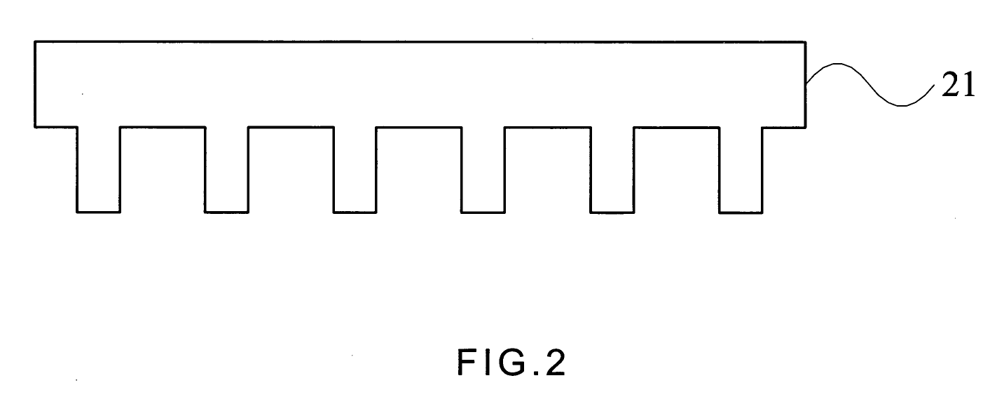

(a) Obtaining a template 11; As shown in FIG. 2, a template 21 is obtained, where the template 21 is a glass (SiO₂) or a wafer having a nano-scaled image obtained through an electron beam lithography.

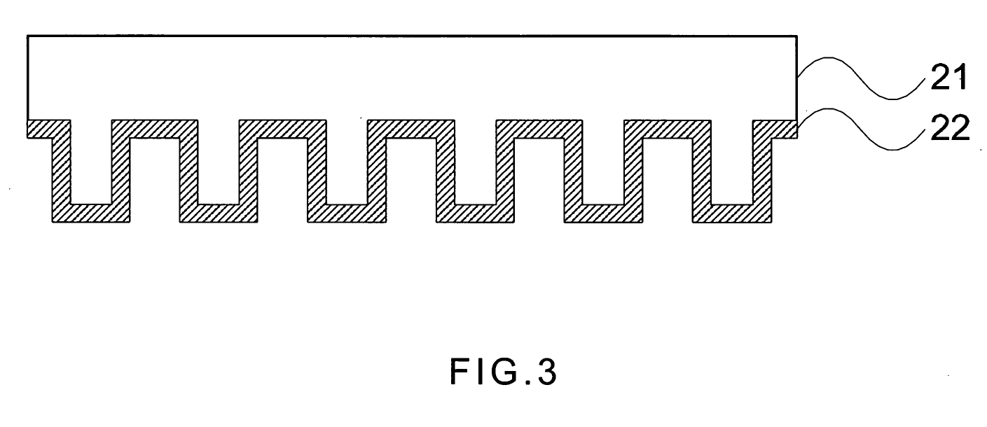

(b) Spin coating the template with a mold release agent 12: As shown in FIG. 3, a benzoxazine monomer is uniformly spin-coated on a surface of the template 21. Then the template 21 is deposed on a hot plate to be heated at 200 Celsius degrees (° C.) for one hour for a hot cross-linkage reaction. Thus, a mold release agent 22 of polybenzoxazine having a low surface energy is formed on the surface of the template, where the polybenzoxazine has a film thickness thinner than 10 nanometers (nm).

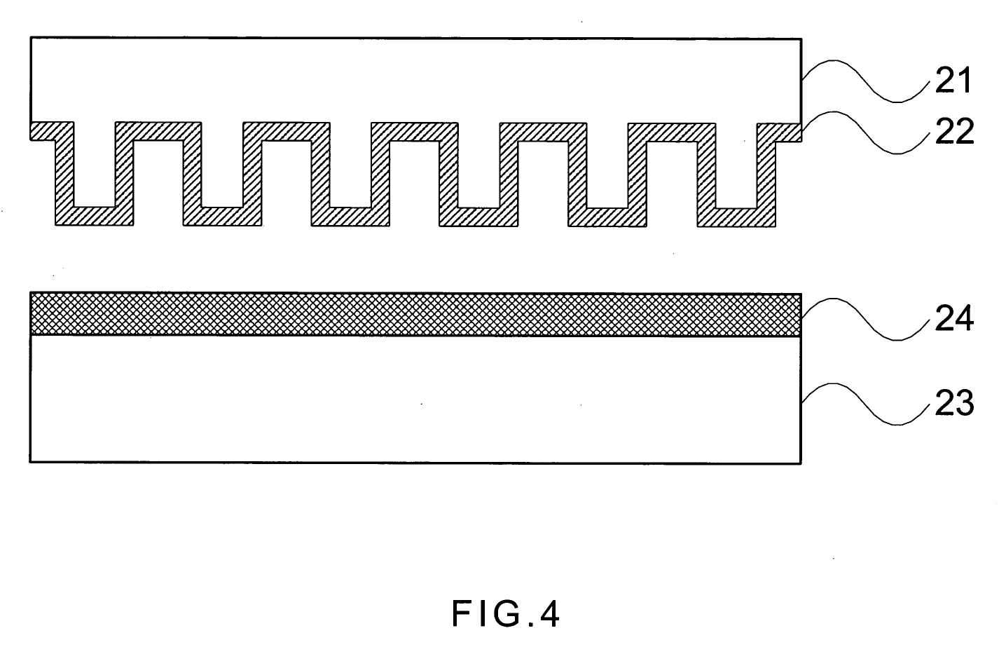

(c) Spin coating a substrate with a polymer resist layer 13: As shown in FIG. 4, a silicon wafer is obtained as a substrate 23 and a layer of a polymer resist 24 is spin coated on the substrate 23.

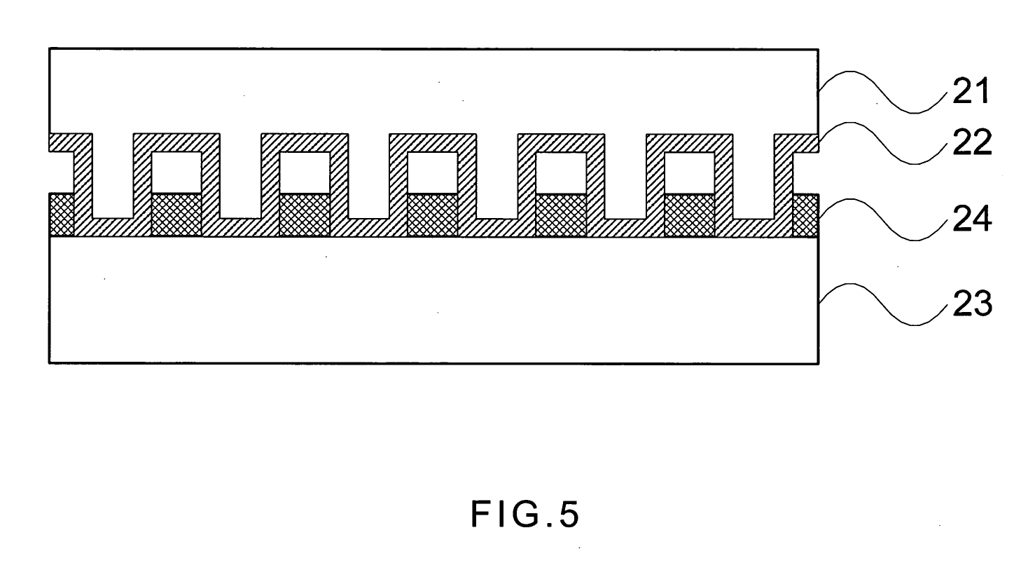

(d) Impressing the substrate with the template 14: As shown in FIG. 5, the template 21 is impressed on the substrate 23 having the polymer resist 24, where the polymer resist 24 left after impressing the template 21 is further removed through reactive ionic etching (RIE).

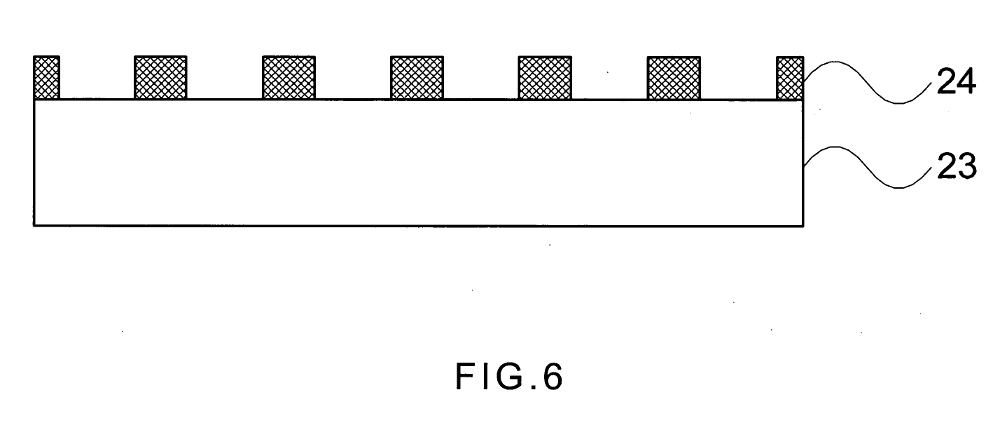

(e) Obtaining an imprinted image 15: As shown in FIG. 6, a fine imprinted image is obtained on the surface of the polymer resist 24 in the end.

On using the present invention, the polybenzoxazine is utilized as a mold release agent 22 of the template 21 and the polybenzoxazine is a thermoset cross-linkage polymer. Through a liquid droplet system depending on contact angle, a lower surface energy of the template 21 than that of Teflon is confirmed. Hence, the mold release agent 22 of the polybenzoxazine having a low surface energy is an excellent packing material for imprinting.

In order to lower the adhering force on departing the template 21 from the polymer resist 24, the present invention processes the benzoxazine monomer through a hot cross-linkage reaction to form a polybenzoxazine film as a mold release agent 22 on the surface of the template 21. The contact surface between the polybenzoxazine and the template 21 has a strong adhering force. In the other hand, on the surface where the polybenzoxazine contacts with the air, the molecule structure is rearrange during the hot cross-linkage process so that a strong intramolecular force is formed and the surface energy is greatly lowered. Therefore, the adhering force between the template 21 and the polymer resist 24 is conquered to obtain a fine imprinted image.

In addition, the benzoxazine monomer is totally resolved in a solution so that no particle appears. And no byproduct is produced during the reaction of the benzoxazine so that no pollution is produced. In short, the present invention has a high stability and a low cost with easy-obtained source material.

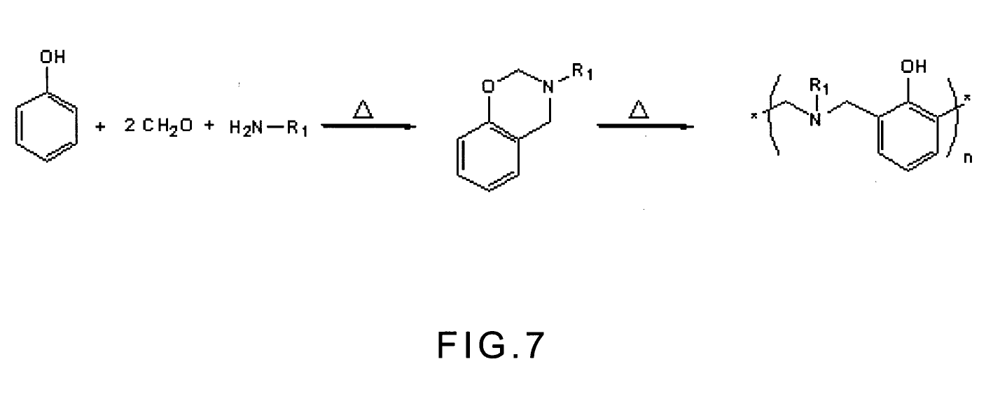

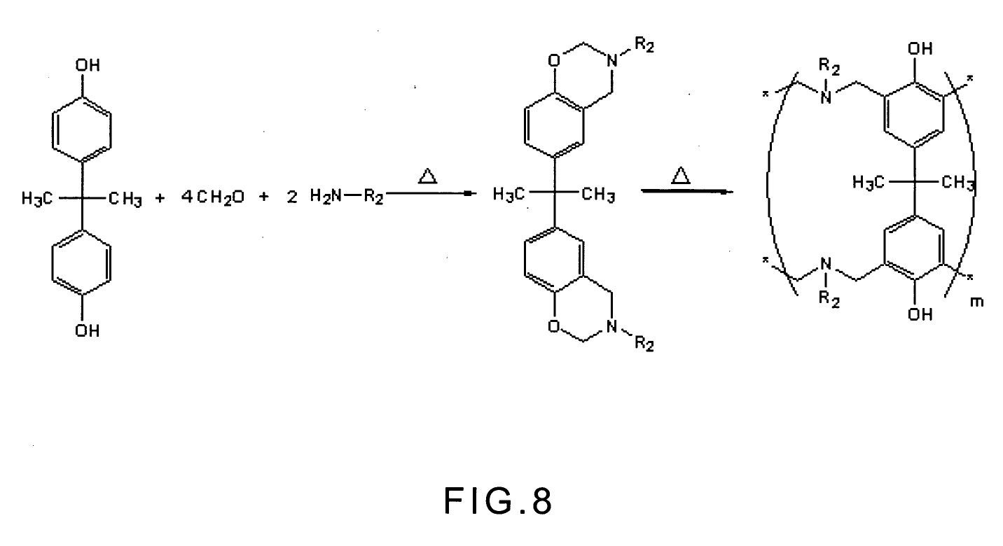

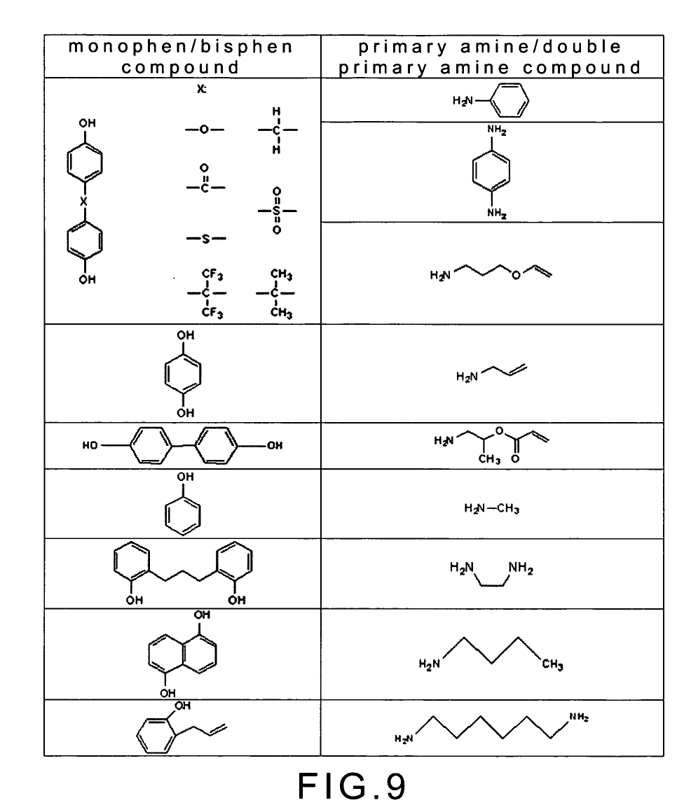

Please refer to FIG. 7 to FIG. 9, which are views showing a chemical structure of a mono-functional group polybenzoxazine and a dual functional group polybenzoxazine; and a view showing a chemical structure of the benzoxazine monomer synthesized. As shown in the figures, a polybenzoxazine according to the present invention is obtained with at least one benzoxazine monomer through a ring-opening addition polymerization. The benzoxazine monomer is a mono-functional group, whose chemical structure is

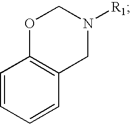

or is a dual functional group, whose chemical structure is

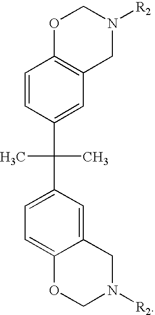

Or, the polybenzoxazine is obtained with more than two benzoxazine monomer through a hot cross-linkage reaction.

The mono-functional group monomer is obtained through a reaction with a few monophen compounds and primary amine. And the dual functional group monomer is obtained through a reaction of a few bisphen compounds, formaldehyde and primary amine; or of a few monophen compounds, formaldehyde and double primary amine

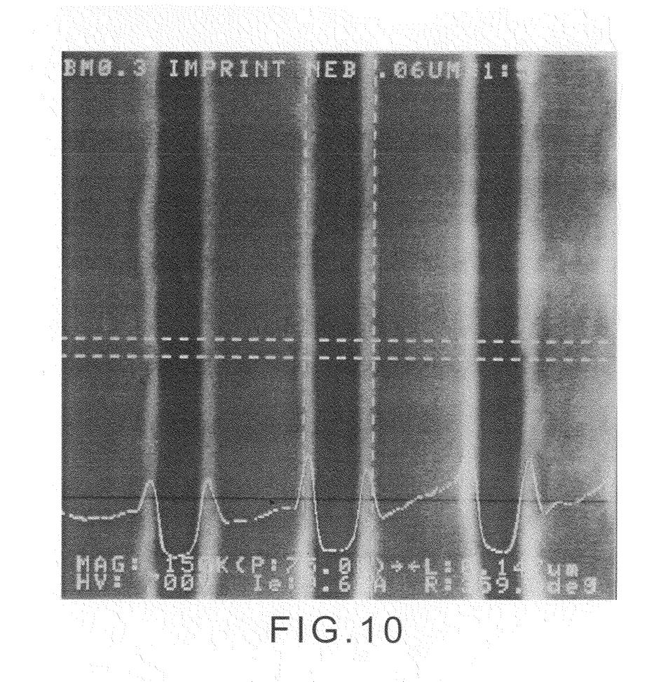

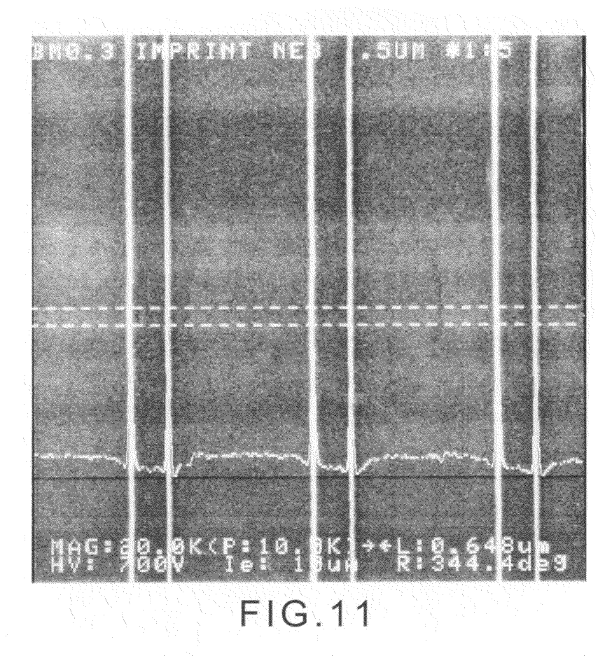

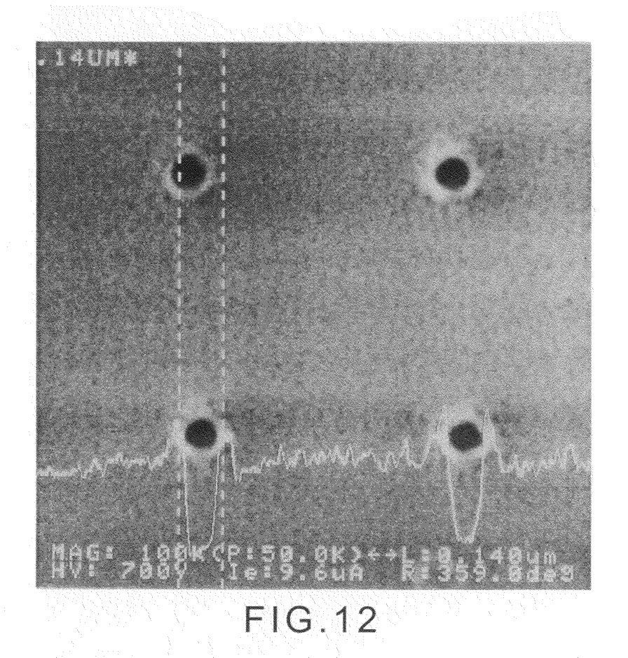

Please refer to FIG. 10 to FIG. 12, which are views showing imprinted images of 147 nanometers (nm), 648 nm and 140 nm. As shown in the figures, fine imprinted images are obtained by imprinting with templates having a mold release agent according to the present invention.

To sum up, the present invention is a nano-imprinting method using a material having a surface energy, where a mold release agent of polybenzoxazine is obtained with benzoxazine monomer through a hot cross-linkage reaction; and where a surface energy is reduced by molecules of the mold release agent to conquer an adhering force on departing a template from a polymer resist during imprinting.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A nano-imprinting method using a material having a surface energy, comprising steps of:
(a) obtaining a template;
(b) uniformly spin coating a mold release agent on a surface of said template;
(c) spin coating a substrate with a layer of a polymer resist;
(d) impressing said substrate with said template having said layer of said polymer resist; and
(e) obtaining an imprinted image on a surface of said polymer resist,
wherein said mold release agent is a polybenzoxazine having a surface energy smaller than an intramolecular force.

2. The nano-imprinting method according to claim 1,
wherein said template is made of a material selected from a group consisting of a glass and a wafer.

3. The nano-imprinting method according to claim 1,
wherein said template has a nano-scaled image obtained through an electron beam lithography.

4. The nano-imprinting method according to claim 1,
wherein said substrate is a silicon wafer.

5. The nano-imprinting method according to claim 1,
wherein, after said substrate is impressed with said template, said polymer resist left is further removed through a reactive ionic etching (RIE).

6. The nano-imprinting method according to claim 1,
wherein said polybenzoxazine is obtained from a benzoxazine monomer processed through a hot cross-linkage reaction at 200 Celsius degrees (° C.) for one hour.

7. The nano-imprinting method according to claim 6,
wherein said benzoxazine is a mono-functional group monomer having a chemical structure of

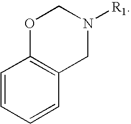

8. The nano-imprinting method according to claim 7,
wherein said mono-functional group monomer is obtained by a reaction of monophen compound, formaldehyde and primary amine.

9. The nano-imprinting method according to claim 6,
wherein said benzoxazine is a dual functional group monomer having a chemical structure of

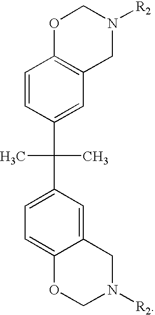

10. The nano-imprinting method according to claim 9,
wherein said dual functional group monomer is obtained by a reaction of bisphen compound, formaldehyde and primary amine.

11. The nano-imprinting method according to claim 9,
wherein said dual functional group monomer is obtained by a reaction of monophen compound, formaldehyde and double primary amine.

12. The nano-imprinting method according to claim 1,
wherein said polybenzoxazine is obtained from more than two benzoxazine monomers through a hot cross-linkage reaction.

13. The nano-imprinting method according to claim 1,
wherein said polybenzoxazine is a cross-linkage polymer.

14. The nano-imprinting method according to claim 1,
wherein said polybenzoxazine has a film thickness thinner than 10 nanometers (nm).
